(19) United States
(12) Patent Application Publication
(10) Pub. No.: US 2005/0264217 A1
(43) Pub. Date: Dec. 1, 2005

(54) Controller for power protection

(76) Inventors: Trevor Lee Huston, Venice, FL (US); Ching Jin Tseng, Peitou Taipei City (TW); Yih Fang Chiou, Hsichih (TW)

Correspondence Address: SoCAL IP LAW GROUP LLP, 310 N. WESTLAKE BLVD. STE 120, WESTLAKE VILLAGE, CA, 91362, US

(21) Appl. No.: 10/859,480

(22) Filed: Jun. 1, 2004

(51) Int. Cl. B60Q 1/00

(52) U.S. Cl. 315/77

(57) ABSTRACT

There is disclosed a controller for power protection. The controller may comprise a switch for activating a power converter. The controller may comprise a circuit coupled with the switch. The circuit may open the switch when an input voltage decreases below a first voltage. The circuit may close the switch when the input voltage increases above a second voltage. The second voltage may be greater than the first voltage.

### NOTICE OF COPYRIGHTS AND TRADE DRESS

A portion of the disclosure of this patent document contains material which is subject to copyright protection. This patent document may show and/or describe matter which is or may become trade dress of the owner. The copyright and trade dress owner has no objection to the facsimile reproduction by any one of the patent disclosure as it appears in the Patent and Trademark Office patent files or records, but otherwise reserves all copyright and trade dress rights whatsoever.

### BACKGROUND OF THE INVENTION

1. Field of the Invention

The invention relates to power controls utilized in mobile systems.

2. Description of the Related Art

Modern vehicles have advanced batteries which are more compact, have less mass, greater capacity, deeper electrical cycling, faster charging, and longer effective life than older style batteries. An example of an advanced battery is a lithium ion battery pack used for starter motor and alternator applications in an electric hybrid vehicle. Lithium ion battery packs have been helpful in power assist and stop and go situations where very high pulse power is required to power electric systems within the vehicle.

Modern mass transit vehicles have complex electrical systems which depend on electrical power including air conditioning, emergency lighting, computing systems, opening of automatic doors, and electronic communications. Many mass transit operators, including local governments, mandate that a mass transit vehicle sustain electrical systems via battery power in excess of one hour upon engine failure.

However, even the best batteries may experience reduced effective life cycle and reduced capacity based on the loads connected to the battery, the frequency of electrical cycling of the battery, and the environment in which the battery operates.

### DESCRIPTION OF THE DRAWINGS

FIG. 1 is a block diagram of a simplified electrical system.

FIG. 2 is a block diagram of a controller used for power protection.

FIG. 3 is a voltage graph representing hysteretic behavior.

FIG. 4 is a voltage graph representing hysteretic behavior.

FIG. 5 is a circuit diagram of a power supply that provides power protection.

### DETAILED DESCRIPTION OF THE INVENTION

Throughout this description, the embodiments and examples shown should be considered as exemplars, rather than limitations.

Description of Systems

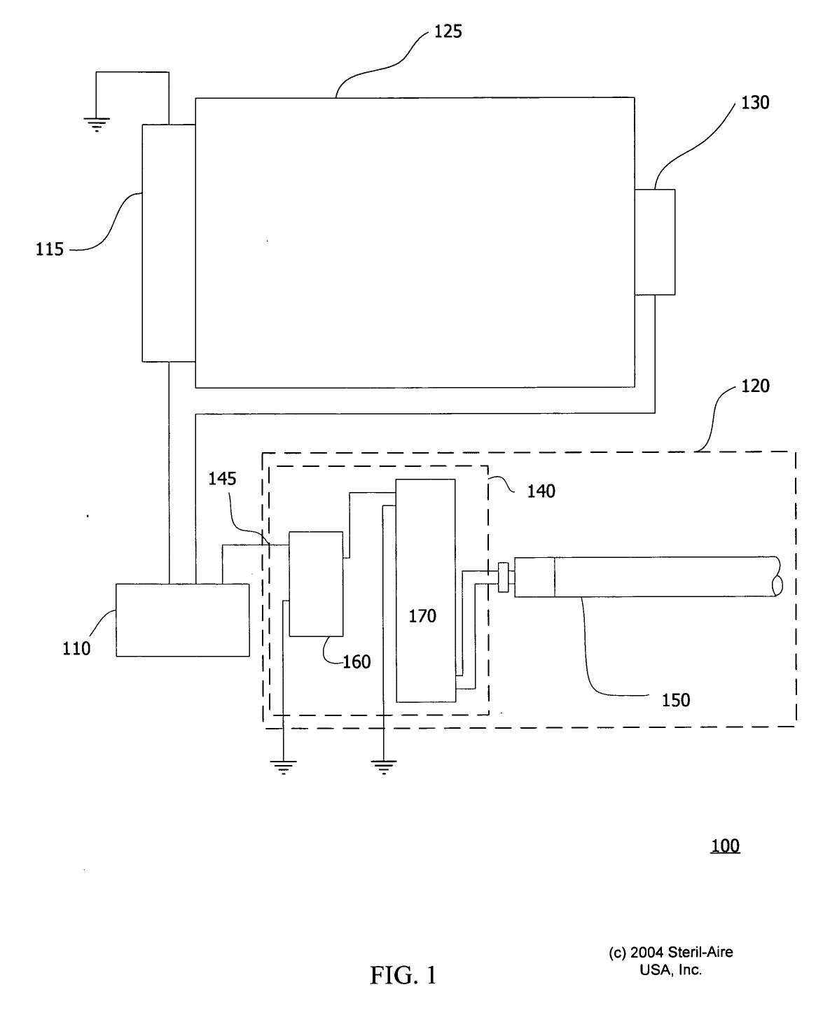

Referring now to FIG. 1, there is shown a block diagram of an electrical system 100. The electrical system 100 may be installed in a vehicle. Movable machines and systems which can transport passengers and/or goods over land, under water, over water, through the air, and into space will be referred to as vehicles. Vehicles may be powered or unpowered.

The electrical system 100 may include a battery 110, a first load 115, a second load 120, and an alternator 130. The first load 115 may be electrically connected to the battery 110. The second load 120 may be electrically connected to the battery 110. The alternator 130 may be electrically connected to the battery 110.

A cell, group of cells, electrical device or system which converts stored chemical and/or mechanical energy into electrical energy by a reversible chemical and/or mechanical process, and can provide electrical power to a circuit or system is referred to as a battery. The battery 110 may be supplemented with or substituted with an alternator, a solar cell, an industrial building's AC power, and a household AC power. The battery 110 may be selected based on the type of vehicle. For example, a battery 110 for a mass transit bus may be a 12V or 24V lithium ion battery.

The term load refers to one or a group of electrical, electromechanical, and electrochemical devices and/or systems to which electric power is delivered for consumption. The first load 115, for example purposes, may be a starter motor, a heat, ventilation and air condition (HVAC) system, or other. The first load 115 may be mechanically coupled to an engine 125.

An engine is a machine or system for converting energy (in such forms as heat, chemical energy, nuclear energy, radiation energy, pressurized gas, and the potential energy of elevated water) into mechanical force and motion. To start the engine 125, mechanical energy may be required from a starter motor, such as the first load 115. Thus, when generating mechanical energy, the first load 115 may draw electrical power from the battery 110. The voltage of the battery 110 may decrease when the first load 115 is drawing more electrical power from the battery 110 than is being provided to the battery 110.

A machine or system for converting mechanical energy from an engine into electric power is referred to as an alternator. The alternator 130 may provide AC or DC power. The alternator 130 may be substituted with a household outlet providing AC current, a high speed electric charge station for electric vehicles, or otherwise. The alternator 130 may be mechanically coupled to the engine 125. While the engine 125 is running, the mechanical energy of the engine 125 may drive the alternator 130, which, in turn, may generate electric power. The alternator 130 may charge the battery 110.

The manufacturer of the battery 110 may recommend a maximum power that may be provided to all loads. The manufacturer of the battery 110 may also recommend a maximum frequency for switching power to the loads. When loads drawing power from a battery exceeds the recommended maximum power, the battery is functioning under excessive loading. Excessive loading and/or cycling of applying electrical loads may cause harm to the battery 110. The harm may include premature wear, reduction of charge capacity or failure. Excessive loading may be experienced when, for example, the first load 115 is a starter motor and is starting the engine of a mass transit bus. Excessive loading may also be experienced if the battery 110 is concurrently powering multiple loads. Excessive loading may be short term or longer term.

The manufacturer of the battery 110 may recommend a minimum operating voltage for the battery 110. If the battery 110 provides power to a load when the power source 110 is operating at a voltage below the recommended minimum voltage, then the power source 110 may be harmed. A low voltage condition is when a battery is at a voltage below the recommended minimum voltage.

An example of when the battery 110 may experience a low voltage condition is described as follows: When the engine is not running 125, the alternator 130 will not be charging the battery 110. The second load 120 and/or other loads may draw energy from the battery 110 while the battery 110 is not being charged. The drain on the battery 110 may cause a low voltage condition.

Another example of when the battery 110 may experience a low voltage condition is described as follows: When the first load 115 is a starter motor starting the engine 125 of a bus, the first load 115 may draw enough power to cause the battery 110 to experience a low voltage condition

The manufacturer of the battery 110 may recommend a maximum operating voltage for the battery 110. If the battery 110 provides power to a load when the power supply 110 is operating at a voltage above the recommended maximum voltage, then the power supply may be harmed. A high voltage condition is when a battery is at a voltage above the recommended maximum voltage. An example of when the battery 110 may experience a high voltage condition is when the battery 110, the alternator 130 or another load malfunctions or fails.

If the power supply 140 operates in the high voltage condition, the power supply 140 may prematurely fail. The conditions of excessive loading, low voltage and high voltage may cause short term and long term damage to performance and structure of the components of the electrical system. The damage may be permanent.

The second load 120, for example purposes, may be a power supply 140 electrically connected to an electric discharge device 150 (shown in a cut-away view).

The term electric discharge device refers to an apparatus which emits radiation caused by an electric discharge between two electrodes in a tube. An electric discharge is electrical conduction through a gas or vapor in an applied electric field. A tubeis a hollow device used to hold vaporizable materials and gases. A tube may be at least partially translucent. A tube may be constructed of glass, metal, or plastic. Electric discharge device encompasses fluorescent lamps, mercury vapor lamps, low pressure sodium lamps and high pressure sodium lamps.

The electric discharge device 150 may include a vaporizable material, such as mercury. The mercury, when electrically excited, may emit ultraviolet light at a germicidal wavelength. A germicidal wavelength, for example 187 m and 254 nm, is a wavelength of light which retards buildup or accumulation of at least one of mold, bacteria, fungi, viruses, mildew, allergens, spores, yeasts, mycotoxins, and endotoxins. A lamp which emits ultraviolet radiation at a germicidal wavelength is referred to as a germicidal lamp.

The electric discharge device 150 may be required to operate when the battery 110 is not being charged. For example, a municipality may require a germicidal lamp of an HVAC system to operate for 90 minutes while the engine 125 is off and the battery 110 is not receiving a charge. In this condition, the electric discharge device 150 may cause the battery 110 to drain of energy, causing the voltage of the battery 110 to decrease.

If the electric discharge device 150 is operated at a lower voltage or a higher voltage than its standard operating voltage, it may be harmed resulting in a shorter effective life. Standard operating voltage refers to the voltage range between an electronic discharge device manufacturer's recommended minimum voltage and maximum voltage for operating the electric discharge device. The electronic discharge device manufacturer may recommend the minimum voltage and the maximum voltage to prevent premature failure.

If the electric discharge device 150 is repetitively cycled on and off, it may prematurely fail or perform inefficiently. Therefore, low voltage conditions, high voltage conditions, and power cycling may result in more frequent replacement and maintenance of the electric discharge device 150. If low voltage conditions are reduced and frequent power cycling is reduced, maintenance and operational costs may be reduced.

The power supply 140 may include a power input 145, a controller 160 and a power converter 170. The power input 145 may be electrically connected to the battery 110. The power input 145 may receive power from the battery 110. The power supply 140 may be selected based on the type of battery 110 and the type of electric discharge device 150. The power supply 140 may be a single unit, a stand alone unit, multiple distinct components, or other, and may be integrated with a more complex power control system.

An electronic device or system that converts electric power from a form being received to a form which is supplied to a load is referred to as a power converter, The power converter 170 may convert power from DC to AC, from DC to DC, or from AC to DC, or other. The power converter 170 may regulate electric power

A ballast is a power converter that regulates electric power and functions as a starting and control unit for an electric discharge device. The ballast initially provides a voltage to ionize the gas or vaporizable material in the tube. The ballast then controls the power that drives the electric discharge device.

The power converter 170 may be selected based on the type of electric discharge device 150 that it may power. The power converter 170 may include over-current protection via an inline fuse (not shown). The power converter 170 may be adjustable with regard to transforming characteristics, cycling characteristics, and capacity. The power converter 170 may be a stand-alone unit. The power converter 170 may be integral with the electric discharge device 150 or another load.

The controller 160 may be electrically connected to the battery 110. The power converter 170 may be electrically connected to the controller 160. The controller 160 may interface between the battery 110 and the power converter 170. The controller 160 may be integral to the power converter 170 or another component. The controller 160 may be a stand-alone unit. The controller 160 may be integral to a vehicle electrical control unit which controls all electric power in the vehicle. The controller 160 may include one of or a combination of a printed circuit assembly including digital logic, and/or analog circuitry, software, and a general purpose computer including memory and a microprocessor.

The controller 160 may sense input voltage at the power input 145 via a sensor (not shown). The controller 160 may utilize a comparator which generates a predetermined voltage or signal when the input voltage decreases or increases past a recommended minimum voltage. The recommended minimum voltage may be selected based on the recommended minimum voltage of the battery 110, the electronic discharge device 150 or other.

The controller 160 may include multiple circuits for performing multiple functions. The controller 160 may provide delay functionality, hysteresis functionality, timer function, or combinations of these. The functions of the controller 160 may be implemented with an FPGA.

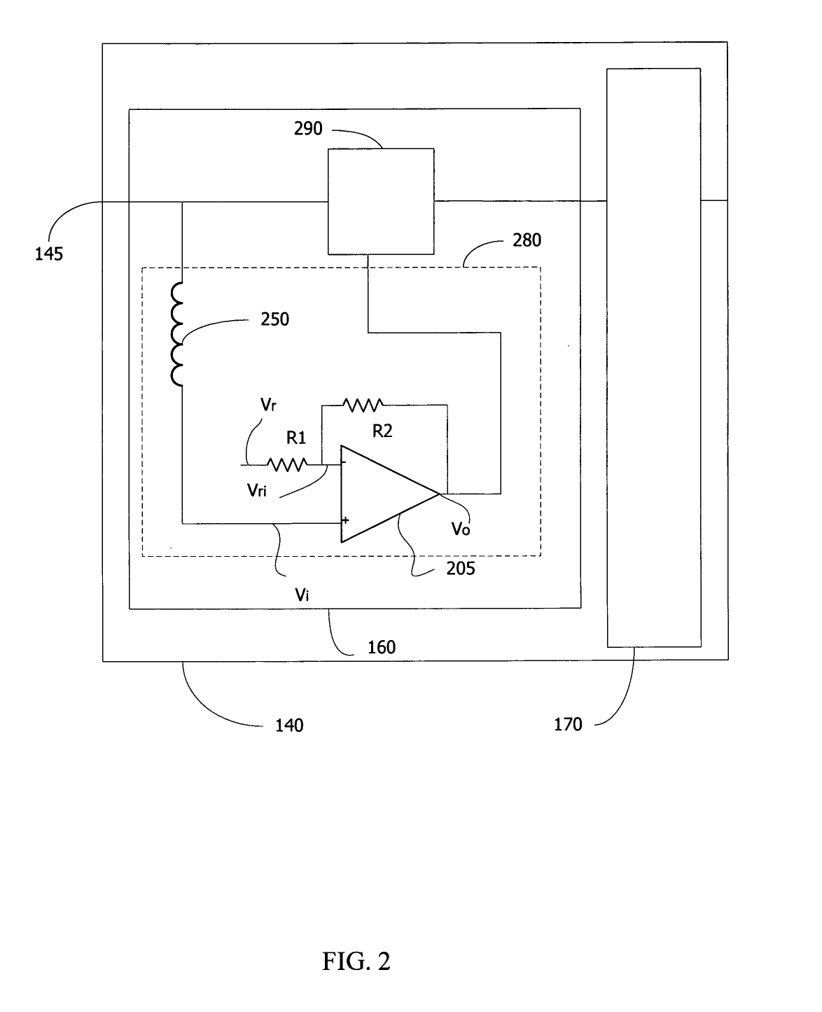

Referring now to FIG. 2, there is shown a schematic of an embodiment of the controller 160. The controller 160 may include a circuit 280 and a switch 290. The term switch refers to any software, digital, semiconductor, analog circuit, or mechanical device which, when closed, allows power to flow, and when open, prevents power from flowing. The switch 290 may be controlled manually, by a motor, by the circuit 280, or other device. The switch 290, when closed, may allow power to flow from the power input 145 to the power converter 170. The switch 290, when open, may prevent power from flowing from the power input 145 to the power converter 170.

The controller 160 may detect when the battery 110 exhibits a low voltage condition. When the controller 160 detects that the battery 110 is in a low voltage state, the controller 160 may cause the switch 290 to open. When the switch 290 is open, power will not flow to the power converter 170. When power is not flowing to the power converter 170, the electric discharge device 150 will not draw power. Because the electric discharge device 150 will not draw power when the battery 110 exhibits a low voltage condition, harm to the battery 110 may be prevented.

The controller 160 may detect when the battery 110 exhibits a high voltage condition. When the controller 160 detects the battery 110 is in a high voltage state, the controller 160 may cause the switch 290 to open. When the switch 290 is open, power will not flow to the power converter 170 nor the electric discharge device 150. Therefore, the power supply 140 and the electric discharge device 150 may be protected from harm caused by a high voltage condition of the battery 110.

When the battery 100 is operating at one of or between the recommended minimum and maximum voltages, it is considered to be operating under a normal operating condition. If the battery 110 is operating under a normal operating condition, the controller 160 may connect the second load 120 to the battery 110 by closing the switch 290. When the switch 290 is closed, power may flow from the battery 110 to the power converter 170.

The circuit 280 may be coupled to the switch 290. The circuit 280 may open and close the switch 290 when the voltage at the power input 145 increases above or decreases below the recommended minimum voltage. The recommended minimum voltage may be predefined, may be set manually or automatically based upon selected conditions and may be static or dynamic.

In a condition where the switch 290 is open and the second load 120 is disconnected from the battery 110, the voltage at the battery 110 may rise above the recommended minimum voltage even though the battery 110 is not receiving power for charging. When the voltage at the battery 110 exceeds the recommended minimum voltage, the circuit 280 may cause the switch 290 to close, electrically connecting the second load 120 to the battery 110.

If the voltage at the battery 110 decreases below the recommended minimum voltage the circuit 280 may cause the switch 290 to open and electrically disconnect the second load 120 from the battery 110. Alternatively, the controller 160 may cause a step-down of power to one or more lower levels. It is possible that the opening and closing of the switch 290 may frequently cycle, causing possible premature failure or deterioration of the battery 110, the electric discharge device 150 the power supply 140, the first load 115, and/or other loads.

The circuit 280 may be configured to reduce the frequency of the cycling. The circuit 280 may delay opening and/or closing of the switch 290. The circuit 280 may include a timer which prevents the switch 290 from closing after it has been opened for a predetermined time. The circuit 280 may be configured to behave with hysteresis to increase the period of cycling.

A hysteresis circuit is a circuit whose output follows the form of a hysteresis loop. A hysteresis loop may be hard or soft edged. The hysteresis circuit may be an analog or digital circuit. The hysteresis circuit may be software logic executed by a general purpose computer.

When the circuit 180 behaves hysteretically, the a circuit 280 causes the switch 290 to open when the voltage at the battery 110 reduces to a first voltage below the recommended minimum voltage. Additionally, the circuit 280 causes the switch 290 to close after the voltage at the battery 110 increases to a second voltage higher than the recommended minimum voltage.

Hysteretic behavior may result in an increase in the period of cycling or prevent cycling of the switch 290. For example, after the switch 290 has been opened and the second load 120 has been disconnected from the battery 110, if the second voltage is higher than the voltage to which the battery 110 will rise to, cycling will be prevented.

The controller 160 may include a timer (not shown). The timer is a device which automatically starts or stops operation of a controller for a predetermined period of time. The timer may be software instructions utilized by a general purpose processor, an analog circuit, or other. The timer may be integrated with the controller 160, the battery 110, or stand alone.

When the controller 160 includes the timer, the controller 160 may detect if the battery 110 is in a steady state. The term steady state refers to the condition when there is zero net change in energy at the battery 110. The battery 110 may be in a steady state if no load is drawing power from the battery 110, if the battery is receiving a charge that entirely offsets all loads applied to the battery 110, or other.

During normal operation of the power charging device, the battery 110 may remain in a steady state when the second load 120 is drawing power from the battery 110. However, the battery 110 may not receive a charge when the alternator 130 ceases operation, for example, when the engine 125 which drives the alternator 130 ceases, or when the sun goes down and solar cells cease generating power.

During the period when the battery 110 receives no charge and the second load 120 continues to draw power from the battery 110, the battery 110 may be drained of electric energy. As electric energy is drained from the battery 110, the voltage at the battery 110 may decrease to the first voltage.

The controller 160 may detect a reduction in voltage at the battery 110. The timer may be triggered by a reduction in voltage at the battery 110. If the battery 110 does not increase in voltage within a predetermined period of time, the timer may trigger the circuit 280 to cause the switch 290 to open. However, when the circuit 280 detects that the voltage increases before the predetermined period of time has lapsed, the timer may reset and wait for a voltage decrease at the battery 110.

The selection of the predetermined period of time may be based on a government mandated safety period where emergency electrical systems must be powered after the power charging device ceases operation.

The controller 160 may include an overvoltage relay (not shown) connected between the power input 145 and the power converter 170. The overvoltage relay may prevent power spikes and/or high voltages from passing through the controller 160. The overvoltage relay may be selected based on the recommended maximum voltage of the power supply 140 and/or the electric discharge device 150. If power spikes are prevented from passing through the controller 160, then the power supply 140 and the electric discharge device 150 may be protected from damage.

The controller 160 may include a general purpose computer with software and/or logic to prevent cycling, to delay switching after a switching operation has occurred, and/or to prevent the switch 290 from closing after it has been opened for a predetermined time.

The circuit 280 may include a comparator 205. The comparator 205 may be a device such as a LM358, LM393, LM311, or other comparator, manufactured by Texas Instruments, Inc., or other company. The comparator 205 may include a voltage reference input Vri, a voltage input Vi, and a voltage output Vo. The circuit 280 may include a voltage reference Vr, a first resistor R1 connected in series between the voltage reference Vr and the voltage reference input Vri. The circuit 280 may include a feedback resistor R2 which is serially connected between the voltage output Vo and the voltage reference input Vri. In this configuration, the circuit 280 is known as a comparator with hysteresis.

The circuit 280 may include an inductor 250. The inductor 250 may cause the circuit 280 to behave with hysteresis. The inductor 250 may cause the circuit 280 to behave with hysteresis based on the inductance of the inductor 250 and the rate of change of voltage provided from the battery 110 to the power input 145. The inductor 250 may cause the voltage at the power input 145 to change at a slower rate than the voltage provided from the battery 110.

By reducing or eliminating excessive loading and/or frequent cycling, the life cycle and/or the load capacity of the battery 110 may be improved. If the life cycle of the battery 110 is improved, frequency of replacement may be reduced resulting in a reduced cost of operation of the vehicle. Additionally, if the controller 160 reduces or prevents degradation of the load carrying capacity of the battery 110, a battery 110 with less mass and less charge capacity may be selected, resulting in less weight to be transported by the vehicle and less cost to operate the vehicle.

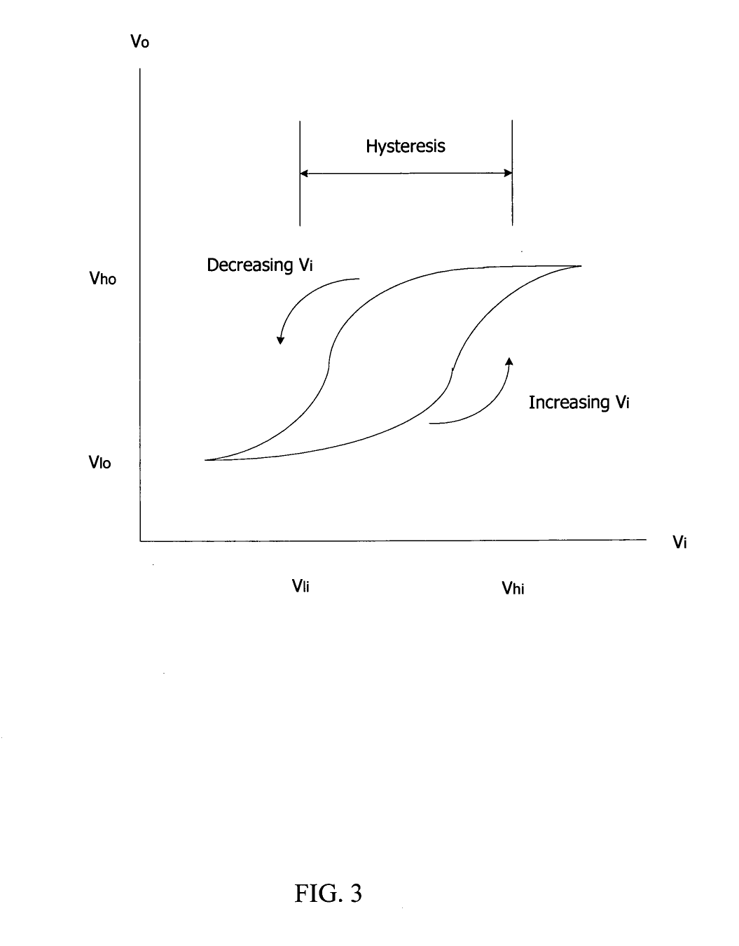

Referring now to FIG. 3, there is shown a graph representing hysteretic behavior caused by the comparator with hysteresis. The y-axis of the graph represents the voltage output Vo. The x-axis represents the voltage input Vi. The comparator 205 may output a low voltage Vlo at the voltage output Vo when the voltage at the voltage input Vi decreases below a first voltage Vli, where the first voltage Vli is less than the voltage at the voltage reference input Vri. The comparator 205 may continue to output the low voltage Vlo until the voltage at the voltage input terminal Vri increase above a second voltage Vhi, where the second voltage Vhi is greater than the voltage at the voltage reference input Vri. When the voltage at the voltage input Vi increase above the second voltage Vhi, the comparator 205 may output a high voltage Vho at the voltage output Vo. The comparator 205 may continue to output the high voltage Vho until the voltage at the voltage input Vi falls below the first voltage Vli.

Hysteretic behavior caused by the comparator with hysteresis may be described by the difference between the first voltage Vhi and the second voltage Vli. Functionally, Vli=(R1/(R1+R2))*(Vlo−Vri)+Vri and Vhi=(R1/(R1+R2))*(Vho−Vri)+Vri. Commonly, hysteresis is measured by the equation (R1/(R1+R2))*(Vho−Vlo). A desired amount of hysteresis may be selected by fixing the ratio of R1/R2.

When the circuit 280 includes the comparator with hysteresis, the comparator 205 may output the low voltage Vlo when the voltage at the power input 145 decreases to the first voltage. The circuit 280 may cause the switch 290 to open when the comparator 205 outputs the low voltage Vlo.

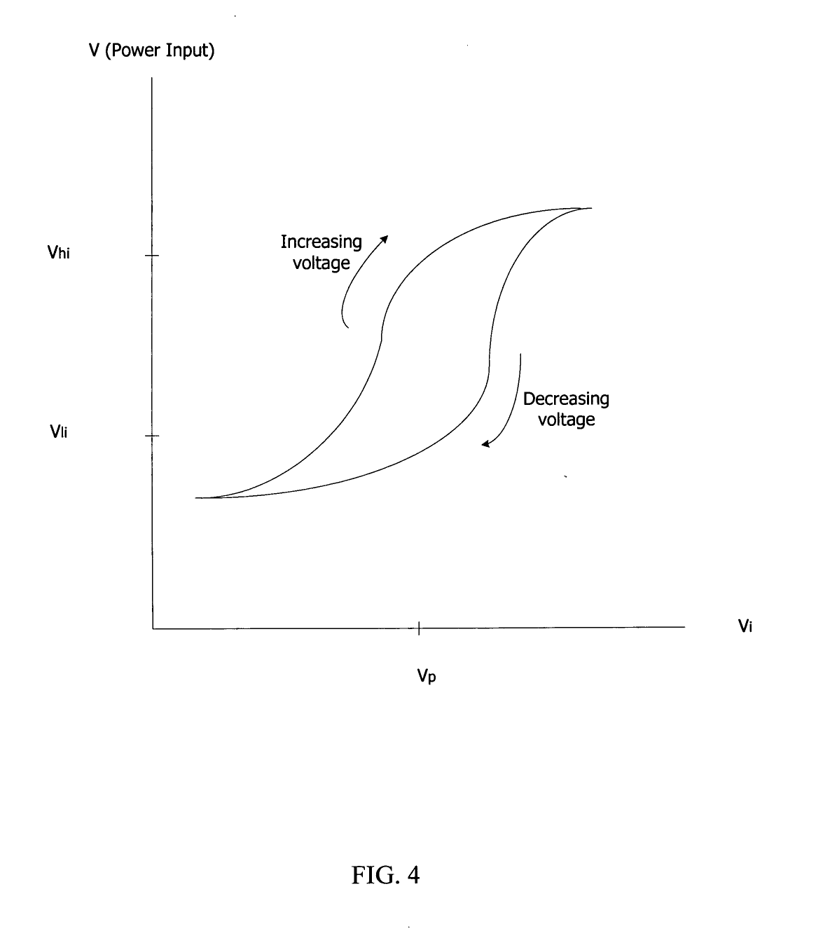

Referring now to FIG. 4, there is shown a graph which represents the hysteretic behavior caused by the inductor 250. The y-axis represents the voltage at the power input 145. The x-axis represents the voltage at the voltage input Vi. The circuit 280 may cause the switch 290 to open or close when the voltage at the voltage input Vi increases above or decreases below the recommended minimum voltage Vp.

Because of hysteretic behavior caused by the inductor 250, the voltage at the voltage input Vi may decrease below the recommended minimum voltage Vp when the voltage at the power input 145 decreases below the first voltage Vli. Additionally, the voltage at the voltage input Vi may increase above the recommended minimum voltage Vp when the voltage at the power input 145 increases above the second voltage Vhi. Moreover, the second voltage Vhi may be greater in magnitude than the first voltage Vli.

The circuit 280 may cause the switch 290 to open when the voltage at the battery 130 decreases below a first voltage Vli and cause the switch 290 to close when the voltage at the battery 130 increases above a second voltage Vhi.

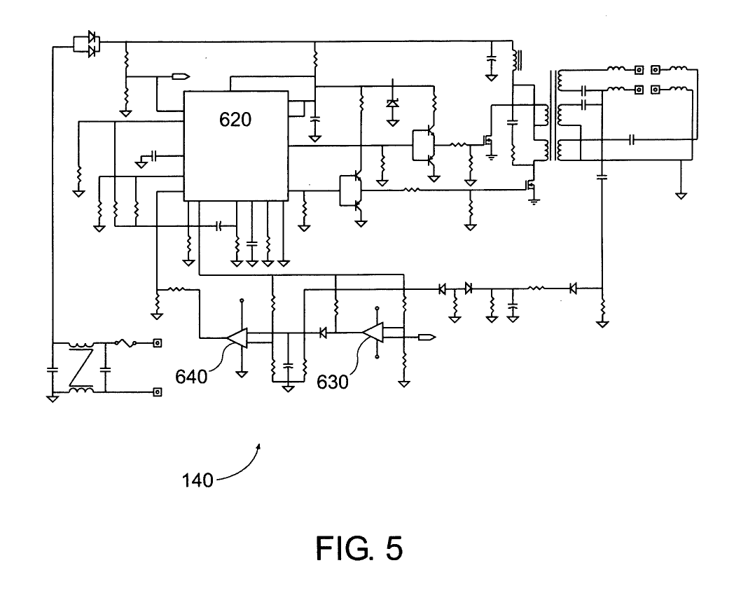

Referring now to FIG. 5, there is shown an electrical schematic of a power supply 140. The power supply 140 of FIG. 5, for example purposes, may be configured to provide a delay function and provide power to an electric discharge device 150. The controller 160 may provide protection to the battery 110 and/or the electric discharge device 150 via a delay function.

The power supply 140 may include a processor 620 to control a pulse width modulator (PWM) switching regulator. An example of the processor 620 is a TL494 controller manufactured by Texas Instruments, Inc., or other processor. The power supply 140 may include a first comparator 630 wherein input pin 3 is electrically connected to the processor 620 pin 14 through resistor R28. The processor 620 pin 14 may be a reference voltage output from the processor 620. The first comparator 630 input pin 2 may be electrically connected to the battery 110. When the voltage at the first comparator 630 input pin 2 is less than the voltage at the first comparator 630 input pin 3, a high voltage may be output at the first comparator 630 output pin 1.

The power supply 140 may include a diode D3 which allows current to pass through the diode D3 when the voltage at the first comparator 630 output pin 1 is high. When current passes through the diode D3, the capacitor C3 is charged as current flows through resistor R25. The time for charging the capacitor C3 may result in a delay for switching.

The delay may be selected to increase the period of any potential on/off switch oscillation. The time duration for the delay in opening the switch may be selected based on the resistance of resistor R25 and the capacitance of the capacitor C3. The time duration for the delay may be related to both the resistance of resistor R25 and the capacitance of the capacitor C3. For protecting the battery 110, a time duration for the delay may be 20 ms, 5 seconds, 4½ minutes, or other.

The power supply 140 may include a second comparator 640 wherein input pin 5 may be electrically connected to the capacitor C3. The second comparator 640 input pin 6 may be electrically connected to the processor 620 pin 14 through resistor R15. When the voltage at the second comparator 640 input pin 6 is less than the voltage at the second comparator 640 input pin 6, the second comparator 640 may output a high voltage at the second comparator 640 output pin 7.

The processor 620 may include input pin 16 which may be electrically connected to the second comparator 640 pin 7 via resistor R3. When the voltage at the processor 620 pin 16 reads a high input voltage from the second comparator 640, the processor 620 may cause power not to flow to the ballast. The processor 620 may include an oscillator for controlling switching frequency. When the processor 620 pin 16 reads a high input voltage from the second comparator 640, the oscillator may stop oscillating, resulting in the power supply 140 not powering the lamp.

When the input voltage at the first comparator 630 pin 2 is greater than the reference voltage at the first comparator 630 pin 3, the first comparator 630 may output a low voltage at the first comparator 630 pin 1.

When the voltage at the first comparator 630 pin 1 is low, the diode D3 may not allow current to flow through the diode D3. When no current flows through the diode D3, the capacitor C3 may discharge through resistor R24. Discharging of the capacitor C3 may take time and therefore may result in a delay.

After the capacitor C3 discharges, if the voltage at the second comparator 640 pin 5 is less than the voltage at the second comparator 640 pin 6, the second comparator 640 may output a low voltage at the second comparator 640 pin 7. When the processor 620 pin 16 reads a low input voltage from the second comparator 640, the oscillator may oscillate resulting in the power supply 140 providing power to the lamp.

The oscillator may control the frequency of switching at power MOSFETS Q5 and Q6 which in turn drive transformer T1. Transformer T1 may step up the voltage from the input voltage to an output voltage. The output voltage may be applied to the lamp via output pins P2, P3, and P4. The output voltage may be applied to a pulse laser, or a strobe light.

Although exemplary embodiments of the invention have been shown and described, it will be apparent to those having ordinary skill in the art that a number of changes, modifications, or alterations to the invention as described herein may be made, none of which depart from the spirit of the invention. All such changes, modifications and alterations should therefore be seen as within the scope of the invention.

1. A power supply for an electric discharge device comprising a hysteresis circuit.

2. The power supply for an electric discharge device of claim 1, wherein the power supply further comprises:
a ballast for the electric discharge device
a switch for controlling the ballast based on an output of the hysteresis circuit.

3. The power supply of claim 2, wherein
the hysteresis circuit is adapted to cause the switch to open when an input voltage decreases below a first voltage and close the switch when the input voltage increases above a second voltage, the second voltage greater than the first voltage.

4. The power supply of claim 3, wherein
the hysteresis circuit comprises a capacitor for delaying closing of the switch when the input voltage increases above the second voltage.

5. The power supply of claim 3, wherein
the hysteresis circuit comprises a timer for delaying opening of the switch when the input voltage decreases below the first voltage.

6. The power supply of claim 3, wherein
the ballast is adapted to power a germicidal lamp when the switch is closed.

7. The power supply of claim 3, wherein
the hysteresis circuit comprises an overvoltage relay for protecting against power spikes.

8. The power supply of claim 3, wherein
the hysteresis circuit comprises an inductor for reducing cycling harmful to an element selected from the group comprising a battery, the ballast, and the germicidal lamp.

9. The power supply of claim 3, wherein
the power supply further comprises an inline fuse for protecting the ballast from power spikes.

10. The power supply of claim 3, wherein
the hysteresis circuit further comprises a comparator for comparing the input voltage to a reference voltage.

11. The power supply of claim 3, wherein the hysteresis circuit comprises
a comparator for comparing the input voltage to a reference voltage
a capacitor for delaying closing of the switch when the input voltage increases above the second voltage
a timer for delaying opening of the switch when the input voltage decreases below the first voltage.

12. A controller comprising:
a switch for activating a power converter,
a circuit coupled with the switch to open the switch when an input voltage decreases below a first voltage and close the switch when the input voltage increases above a second voltage, the second voltage greater than the first voltage.

13. The controller of claim 12, wherein the circuit comprises a delay capacitor and a delay discharge resistor in parallel with the delay capacitor, the circuit to delay closing of the switch when the input voltage increases above the second voltage.

14. The controller of claim 12, wherein the circuit further comprises a timer to delay the circuit from opening the switch for a predetermined time when the input voltage decreases below the first voltage.

15. The controller of claim 12, wherein the input voltage is received from a vehicle battery.

16. The controller of claim 12, wherein closing the switch causes the power converter to power a germicidal lamp electrically coupled to the power converter.

17. The controller of claim 12, further comprising an overvoltage relay, the overvoltage relay coupled with the circuit, to prevent power spikes.

18. A controller comprising:
a switch for activating a power converter,
a hysteresis circuit coupled with the switch for opening and closing the switch based on an input voltage to the power converter, a rate of change of the input voltage, and a recommended minimum voltage, the hysteresis circuit comprising an inductor for reducing cycling harmful to a battery to which the controller is coupled.

19. The controller of claim 18, wherein the hysteresis circuit further comprises a capacitor, and a discharge resistor in parallel with the capacitor, the hysteresis circuit for delaying closing of the switch when the input voltage increases above the recommended minimum voltage.

20. The controller of claim 18, wherein the hysteresis circuit further comprises a timer for delaying opening of the switch for a predetermined time when the input voltage decreases below the recommended minimum voltage.

21. The controller of claim 18, wherein the input voltage is provided by a vehicle battery.

22. The controller of claim 18, wherein closing the switch activates a ballast electrically connected to a germicidal lamp.

23. The controller of claim 22, further comprising an inline fuse electrically coupled to the ballast whereby the inline fuse protects the ballast from power spikes from the battery.

24. A controller comprising:
a switch for activating a power converter, the switch to provide a power input voltage to the power converter,
a delay circuit for opening and closing the switch comprising
a comparator for comparing the power input voltage to a recommended minimum voltage,
a capacitor coupled with the comparator, the capacitor in series with an input resistor, the capacitor in parallel with a discharge resistor
the delay circuit to delay opening of the switch for a first predetermined time when the power input voltage increases above the recommended minimum voltage, and to delay closing of the switch for a second predetermined time when the power input voltage decreases below the recommended minimum voltage.

25. The controller of claim 24, wherein the delay circuit further comprises a timer for delaying opening of the switch for a predetermined time after the power input voltage decreases below the recommended minimum voltage.

26. The controller of claim 24, wherein the input voltage is provided by a vehicle battery.

27. The controller of claim 24, wherein closing the switch activates a ballast, whereby the ballast is electrically connected to and powers a germicidal lamp.

28. A controller comprising:
a switch for activating a power converter,
a circuit for opening and closing the switch, the circuit comprising a comparator, a timer for delaying opening of the switch for a predetermined time when the comparator indicates that a power input voltage is less than a recommended minimum voltage.

29. The controller of claim 28, wherein the power input voltage is provided by a vehicle battery.

30. The controller of claim 28 wherein closing the switch activates a ballast, the ballast electrically connected to power a germicidal lamp.

31. A process of controlling electricity provided to a power converter comprising:
detecting when an input voltage decreases below a first voltage,
opening a switch when the input voltage decreases below the first voltage, wherein opening the switch de-activates the power converter,
detecting when the input voltage increases above a second voltage, the second voltage greater than the first voltage,
closing the switch when the input voltage increases above the second voltage, wherein closing the switch activates the power converter.

32. The process of controlling electricity provided to a power converter of claim 31, further comprising:
delaying, for a predetermined time, closing of the switch when the input voltage increases above the second voltage.

33. The process of controlling electricity provided to a power converter of claim 31, further comprising:
delaying, for a predetermined time, opening of the switch when the input voltage decreases below the first voltage.

34. The process of controlling electricity provided to a power converter of claim 31, further comprising:
receiving the input voltage from a vehicle battery.

35. The process of controlling electricity provided to a power converter of claim 31, further comprising an overvoltage relay preventing power spikes.

36. A process of controlling electricity provided to a power converter comprising:
opening and closing a switch based on an input voltage to the power converter, a rate of change of the input voltage, and a recommended minimum voltage, wherein opening the switch deactivates a power converter and closing the switch activates a power converter,
providing inductance to a circuit to reduce cyclic opening and closing of the switch harmful to a battery, the circuit for causing opening and closing of the switch.

37. The process of controlling electricity provided to a power converter of claim 36, further comprising delaying closing of the switch for a predetermined time when the input voltage increases above the recommended minimum voltage.

38. The process of controlling electricity provided to a power converter of claim 36, further comprising delaying opening of the switch for a predetermined time when the input voltage decreases below the recommended minimum voltage.

39. The process of controlling electricity provided to a power converter of claim 36, further comprising receiving the input voltage from a vehicle battery.

40. The process of controlling electricity provided to a power converter of claim 39, further comprising protecting the power converter from power spikes with an inline fuse.

41. A process of controlling electricity provided to a power converter comprising:
comparing a power input voltage to a recommended minimum voltage,
delaying opening of a switch for a first predetermined time when the power input voltage increases above the recommended minimum voltage, wherein opening the switch de-activates the power converter
delaying closing of the switch for a second predetermined time when the power input voltage decreases below the recommended minimum voltage, wherein closing the switch activates the power converter.

42. The process of controlling electricity provided to a power converter of claim 41, further comprising providing an input voltage from a vehicle battery.

43. The process of controlling electricity provided to a power converter of claim 42, wherein closing the switch causes a ballast to power a germicidal lamp.
